(19) United States
(12) Patent Application Publication
(10) Pub. No.: US 2008/0245538 A1
(43) Pub. Date: Oct. 9, 2008

(54) Automatic Stove Top Fire Extinguisher

(76) Inventor: Thomas Joe Durham, Hillsboro, TX (US)

Correspondence Address: Thomas Joe Durham, PO Box 742, Hillsboro, TX, 76645, US

(21) Appl. No.: 12/055,534

(22) Filed: Mar. 26, 2008

Related U.S. Application Data
(60) Provisional application No. 60/910,670, filed on Apr. 8, 2007.

(51) Int. Cl. A62C 3/00; A62C 2/00

(52) U.S. Cl. 169/47; 169/46

(57) ABSTRACT

A fire extinguishing system for use with gas or electric range stove top to automatically deploy and energize an audible alarm. The system includes a pressurized supply of inert gas within an inflatable bag. A grease fire on the stove top breaks the fusible cord and allows the case to open, releasing the inert gas supply. The inert gas inflates a flame resistant bag to cover the burners of the stove top. The bottom of the flame resistant bag is a specific temperature sensitive material that will decompose on contact with the grease fire. As the bottom decomposes, the flame resistant material surrounds the cooking container containing the grease fire. The grease fire becomes isolated by flame resistant materials and inert gas. The bottom two layers of the bag have an additional layer of non-flammable absorbent fiber between the two layers of the decomposing bottom. The decomposing bottom layer releases the non-flammable absorbent fiber into the cooking container containing the extinguished grease fire to absorb the cooking grease and prevent the cooking grease from re-igniting.

### CROSS-REFERENCE TO RELATED APPLICATIONS

Provisional Application No. 60910670, Apr. 8, 2007

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates to a self contained, automatic stove top fire extinguisher, specifically to a more efficient method for isolating, containing and extinguishing a stove top fire. This invention also utilizes a unique and precise method for extinguishing the stove top fire, that is normally grease.

2. The Prior Art

Heretofore, stove top fire extinguishers have used a chemical dispersal method that has lacked the ability to isolate a fire or confine it. The general chemical dispersal method is a less precise method. In the self contained units, the chemical dispersal method also has a limited amount of material to disperse.

Several prior U.S. patents use the vent hood mounted method for the installation of their apparatus. Most of these methods deliver a fire retardant chemical outside the boundary of the actual fire. It has been brought to mention in previous patents that the dispersal method increases the chances of “splashing” the burning grease, thereby spreading the flammable materials.

U.S. Pat. No. 6,276,461 B1 to Stager

Disadvantages

1. Irregular dispersal method or possible clogging of nozzles.

2. No isolation or containment of a grease fire.

U.S. Pat. No. 5,351,760 to Tabor. Jr.

Disadvantages

1. Possible clogging of spray nozzles or nozzle covers with cooking grease.

2. Complex installation required.

3. No isolation or containment of a grease fire.

4. Dependent upon power source to extinguish grease fire.

U.S. Pat. No. 5,490,567 to Speer

Disadvantages

1. Must be manually applied to a grease fire.

2. No audible alarm

U.S. Pat. Nos. 4,773,485 and 4,834,188 to Silverman

Disadvantages

1. Unit is not self contained.

2. Complex installation required.

U.S. Pat. No. 3,653,443 to Dockery

Disadvantages

1. Complex installation required.

### BRIEF SUMMARY OF THE INVENTION

The Automatic Stove Top Fire Extinguisher is a compact module that mounts above the stovetop, preferably within the cavity of a vent hood. When a grease fire occurs, a temperature sensitive fuse releases the spring loaded module halves. The spring forces the two halves of the cylinder module fully open. In so doing, another spring is released to force a pin into an inert gas cartridge within the module and sounds an audible alarm. This inert gas cartridge is internal to an inflatable bag that is comprised of a flame resistant material on four sides. Two of the available commercial materials for such use are manufactured by DuPont called Kevlar and Nomex. Another manufacturer, Thermal Material Systems, Inc. makes a number of variations of the product called Omnisil High Temperature Textiles. Example: “OS1200 mnisil Woven Silica Cloth”. These materials have been tested to withstand a temperature of 2000 degrees Fahrenheit for a period of 24 hours without changing their physical structure.

The bottom of the inflatable bag, being the exception, is comprised of a material that will intentionally decompose at the temperature of a grease fire. Upon inflation of the bag with inert gas, the bottom of the inflated bag that will decompose when exposed to the temperature of a grease fire is applied to the cooking container containing the burning grease. The bottom side decomposes releasing an absorbent fiber (Example: Thermal Materials Systems, Inc-Omnisil Chopped Fibers, ¼ inch to 1.0 inch length) into the pan containing the burning grease and also allows the inflatable flameproof sides of the bag to isolate the fire. The grease fire is now contained within the flame resistant compartment of the bag which is inflated with inert gas. The inert gas evacuates the oxygen necessary to support the grease fire and the absorbent fiber released from the decomposing bottom absorbs the grease contents, effectively reducing the grease capacity to reignite.

It is therefore an object of this invention to provide means, by which a self contained fire extinguishing module may isolate the fire, contain the high temperature of the grease fire, extinguish the fire and greatly diminish the flammable capabilities for the remaining grease of the stove top fire.

It is a further object of the invention to provide an automatic fire extinguishing module that may easily be adjusted for positioning, over the stove, by the average retail consumer.

It is also an object of this invention to provide means for an automatic audible alarm to be sounded when the stove top fire extinguisher is deployed.

It is another object of this invention to be completely self-contained without dependencies on outside power sources to operate properly and extinguish a stove top grease fire.

It is yet another object of this invention to avoid the unnecessary dispersal of excessive fire retardant chemicals onto surrounding areas of the stove, when the extinguisher is deployed.

In accord with these objects and others which will be discussed below, the fire extinguishing module of the present invention broadly comprises, within a vent hood mounted case, a thermal fuse (Example: Nylon cord) for melting when a grease fire temperature is present, the automatic mechanical opening of the mounted case and controlled inflation of a bag. The bag has flame resistant sides, a bottom that will decompose at a grease fire temperature only over the cooking container containing the fire and a layer of absorbent fibers inside the bottom layer. The bag to be filled with an inert gas and positioned onto the entire stove top surface while applying the absorbent fiber directly into the cooking container that contains the burning grease.

Additional preferred aspects of the system include the use of a thermal layer to protect the components internal to the module from ambient cooking heat.

Additional objects and advantages of the invention will become apparent to those skilled in the art upon reference to the detailed description taken in conjunction with the provided drawings.

### BRIEF DESCRIPTION OF THE SEVERAL VIEWS OF THE DRAWING

FIG. 1 is a perspective of the front elevation view of a stove having a vent hood containing a preferred embodiment of my extinguisher after inflation. It is also, an example of a cooking container containing grease that has caught on fire.

FIG. 2 is an exploded view of a preferred form of the Automatic Stove Top Fire Extinguisher before deployment.

FIG. 3 is a front plan view of a preferred form of the Automatic Stove Top Fire Extinguisher in it's entirety, before deployment.

FIG. 4 is a left hand, end view of the Automatic Stove Top Fire Extinguisher before deployment with certain parts being omitted for reasons of clarity.

FIG. 5 is a right hand end view of the Automatic Stove Top Fire Extinguisher before deployment with certain parts being omitted for reasons of clarity.

FIG. 6 is an enlarged front plan partial view, in detail, of some of the components internal to the Automatic Stove Top Fire Extinguisher prior to deployment.

FIG. 7 is an enlarged front plan partial view, in detail, of additional components internal to the Stove Top Fire Extinguisher after deployment.

FIG. 8 is a perspective view of the inflated flame resistant bag deployed from within the Automatic Stove Top Fire Extinguisher to show the final shape, coverage of the stove top and the internal layer of grease absorbent fiber. Also to show how a high temperature grease fire will penetrate the temperature sensitive bag bottom, apply the absorbent fiber directly into the cooking container containing the fire and isolate the fire completely.

FIG. 9, 10, 11, 12 is a sequence of four perspective views during flame resistant bag deployment with certain parts omitted for reasons of clarity.

FIG. 9 is a perspective view of the flame resistant bag prior to inflation.

FIG. 10 is a perspective view of the flame resistant bag partially inflated to demonstrate the approximate pattern of inflation of the top portion, to be unfolded during inflation.

FIG. 11 is a perspective view of the flame resistant bag; more inflated then FIG. 10 to demonstrate the approximate pattern of inflation during the continuation of the inflation process.

FIG. 12 is a perspective view of the flame resistant bag totally inflated to show the desired shape at completion of the inflation sequence.

### DETAILED DESCRIPTION OF THE INVENTION

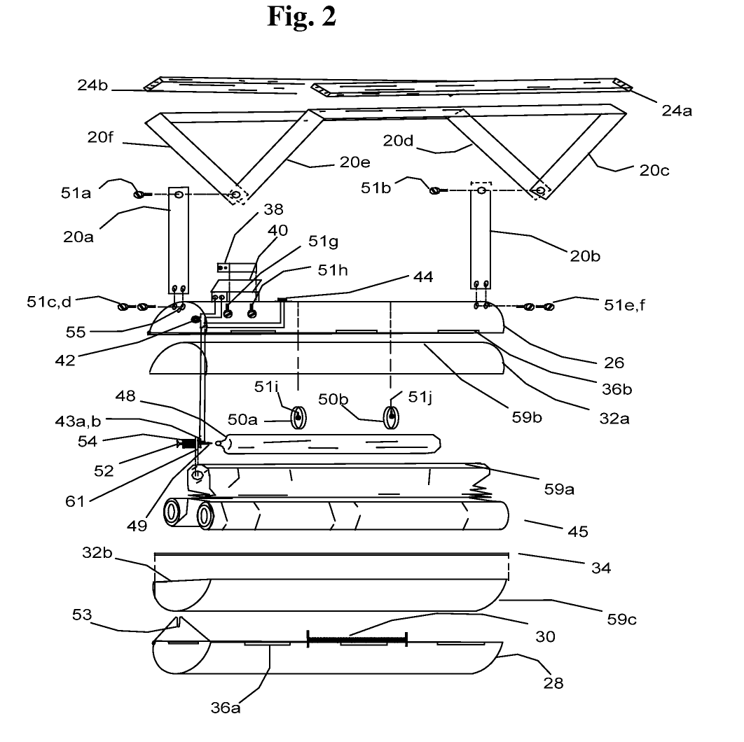

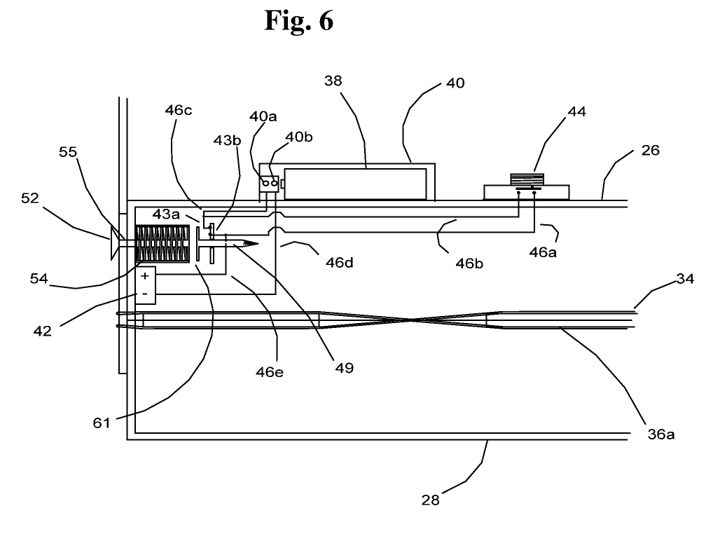

FIG. 2 is comprised of 2 magnetic strips 24a and 24b. 24a and 24b are attached to metal bracket straps 20a through 20f. The metal bracket straps 20a through 20f connect with screws 51a to 51f. The metal bracket straps 20a through 20b are affixed to each end of the case top half 26. Case top half 26 and case bottom half 28 are held together by the case spring hinge 30 and held closed by a fusible cord 34 and fuse cord mounts 36a and 36b. The case insulation 32a and 32b and inflatable bag 45 are held in place by glue 59a through 59c. The battery box 40 is attached to the case top half 26 with screws 51g and 51h. The battery box 40 holds the battery 38. In FIG. 6 the positive battery terminal 40a and the negative battery terminal 40b are wired to the alarm 42, the test button 44 and the wiring contacts 43a and 43b by electrical wire 46a through 46e. The puncture pin 52 of FIG. 2 is held in the end of the case top half 26 through the puncture pin hole 55 with the puncture pin spring 54 on the inside of the case top half 26. The puncture pin 52 is also through the notch 53 on the end of the case bottom half 28. The inert gas cartridge 48 is held in position by clamps 50a and 50b. Clamps 50a and 50b are held to the case top half 26 with the screws 51i and 51j. The inflatable bag 45 is comprised of flame resistant cloth 56 in FIG. 8, flame resistant threads 58, absorbent fibers 60, a fusible bag bottom 62 and flame resistant cords 57a through 57d.

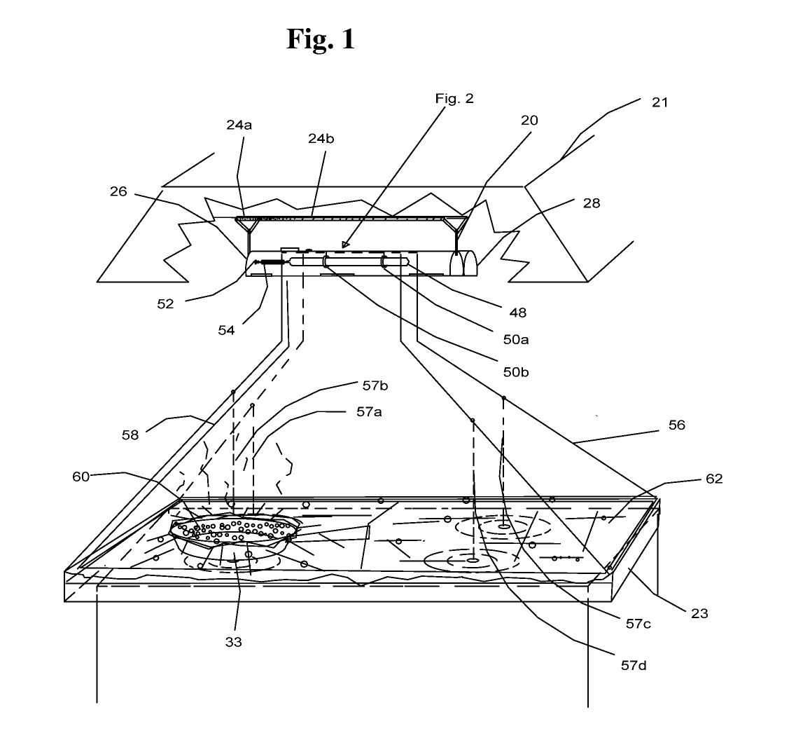

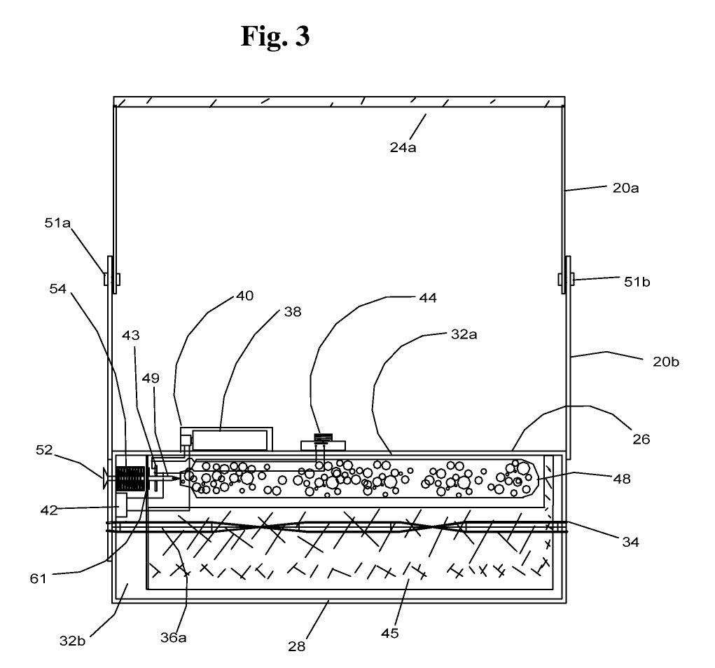

### Operation of Invention—FIGS. 1, 2, 3, 4, 5, 6, 7, 8, 9

The Stove Top Fire Extinguisher in FIG. 1 is positioned in the vent hood 21 above and centrally located over the gas burners or electric elements of stove top 23 by means of magnetic strips of FIGS. 2, 24a and 24b on the metal bracket straps 20c, 20d, 20e and 20f. Metal bracket straps 20c through 20f are attached to metal bracket straps 20a and 20b for adjustment of module position. Metal bracket straps 20a and 20b are attached to the case top half 26. The method used by this invention isolates, contains and extinguishes a stove top grease fire and renders the grease fire incapable of re-igniting as shown in FIG. 1 and FIG. 8.

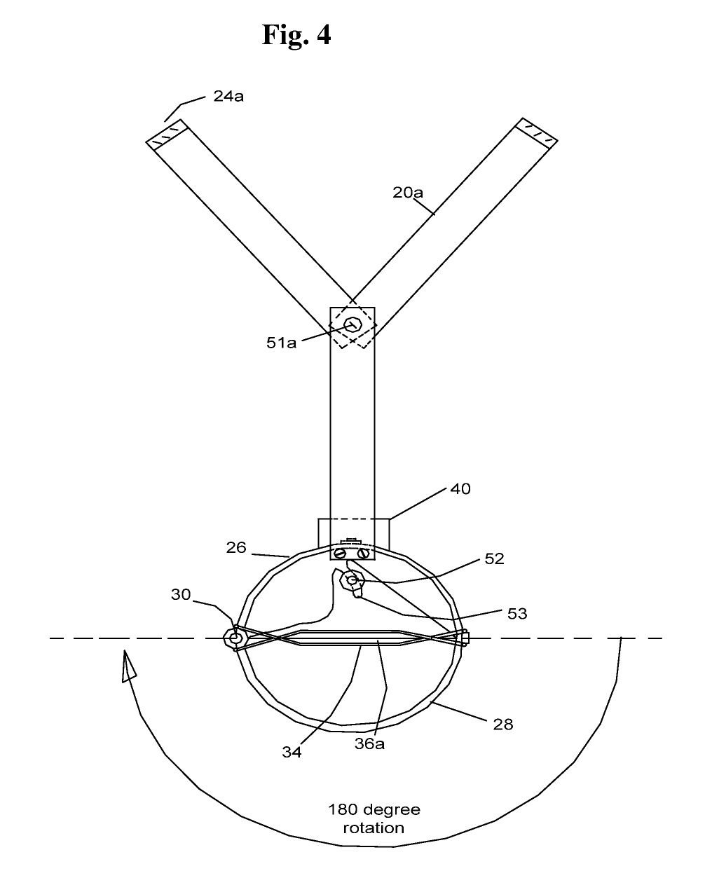

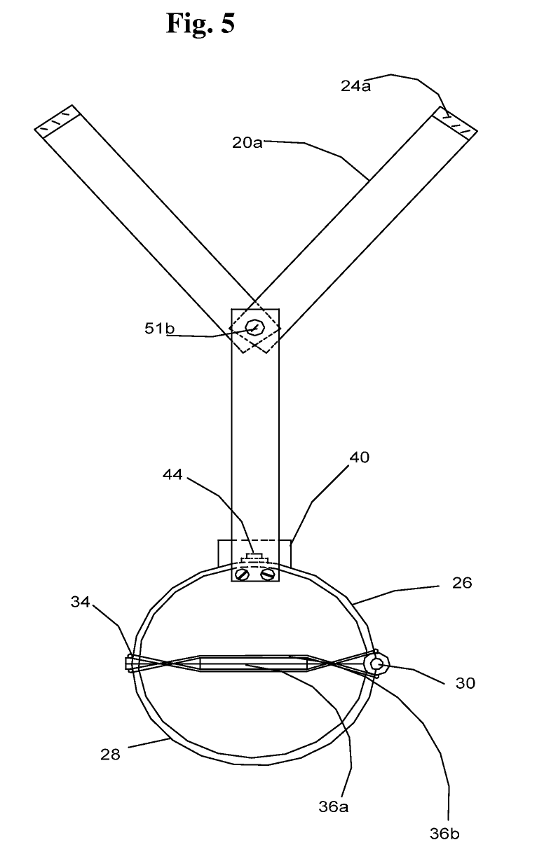

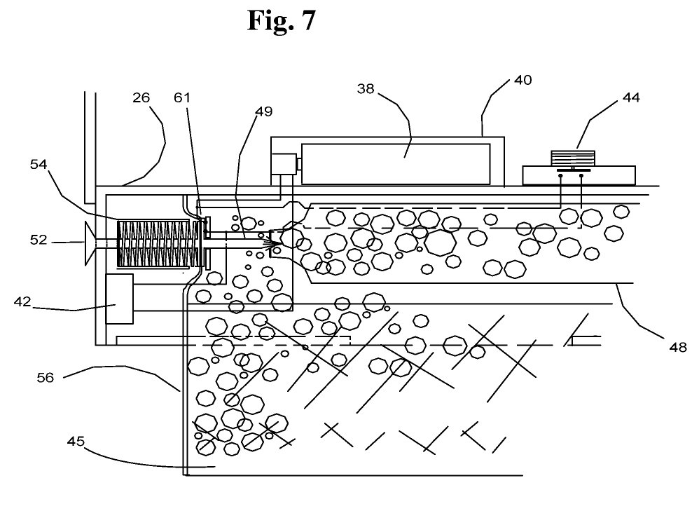

The fusible cord 34 of FIG. 5 is held in place by the fuse cord mounts 36b of the case top half 26 and the fuse cord mounts 36a of case bottom half 28 and the case spring hinge 30. The cooking container 33 in FIG. 1 with a grease fire melts the fusible cord 34 of FIG. 2 that holds the case spring hinge 30 of the case top half 26 and case bottom half 28 closed. After the fusible cord 34 of FIG. 4 has melted (approximately 768 F.), the case spring hinge 30 forces the case bottom half 28 to open in a circular motion to the back and with 180 degrees of rotation. As the case bottom half 28 rotates open, the notch 53 of the case bottom half 28 allows the puncture pin spring 54 of FIG. 7 to force the puncture pin 52 to push the secondary puncture pin 49 for penetration of the inert gas cartridge 48. The inert gas cartridge 48 inflates the inflatable bag 45.

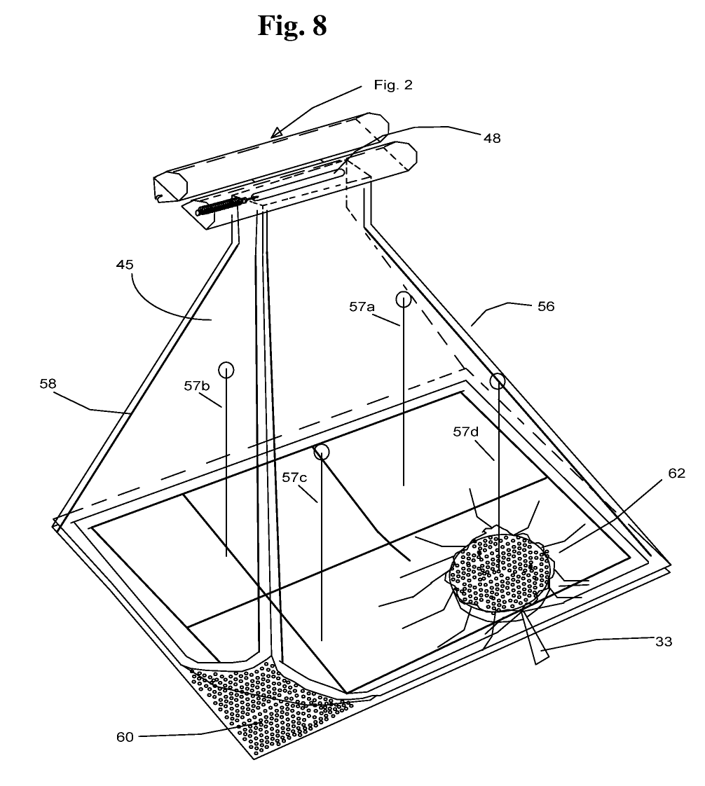

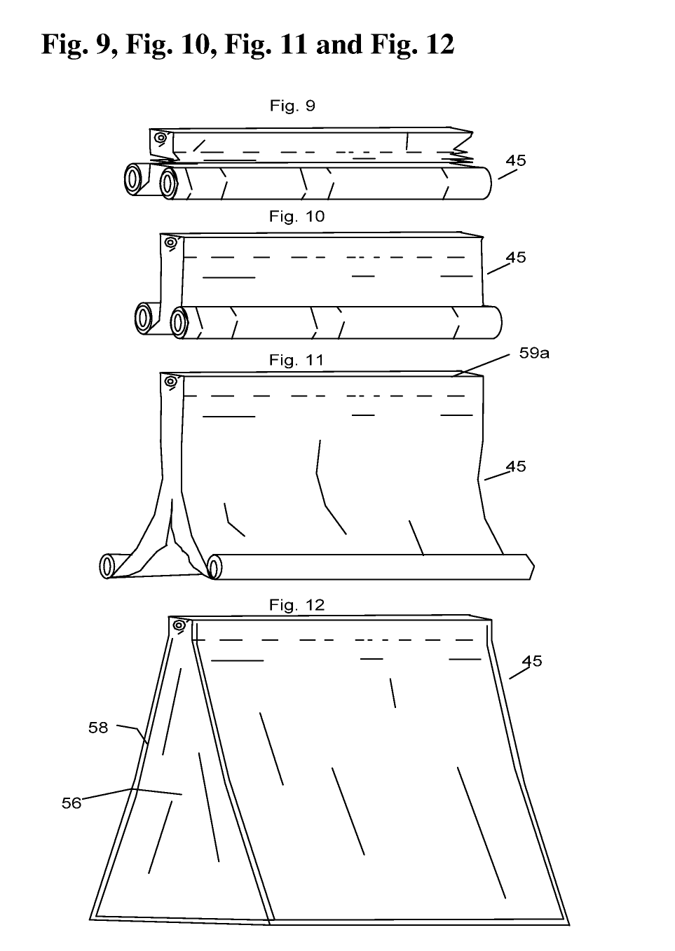

The action of the secondary puncture pin 49 and the inert gas cartridge 48 gas release are demonstrated. The puncture pin 52 passes the energy of the puncture pin spring 54 to the secondary puncture pin 49 by closing the gap 61. The gap 61 has one section of the inflatable bag 45 flame resistant cloth 56 within it. The flame resistant cloth 56 is slack enough to allow the movement of the secondary puncture pin 49. This method allows the inert gas cartridge 48 to be internal to the inflatable bag 45 without the puncture pin 52 penetrating the inflatable bag 45 wall. FIG. 9 through FIG. 12 demonstrates the inflation sequence and starts with the inflatable bag 45 of FIG. 9 completely folded to the approximate internal shape before initiation of deployment, designed in such a way that it will unfold the inflatable bag 45 of FIG. 10, unroll the inflatable bag 45 of FIG. 11 and deploy the inflatable bag 45 of FIG. 12 completely from the center down and outward from the center, in such a way as to cover the entire stove top. The inflatable bag 45 of FIG. 8 has flame proof cords 57a, 57b, 57c, and 57d to add structure to the fusible bag bottom 62 in such a way as to maintain the proper shape. The temperature sensitive fusible bag bottom 62 decomposes and allows the cooking container 33 to become internal to the flame resistant inflatable bag 45. The fire is thereby surrounded by a flame resistant cloth 56 and the gas from the inert gas cartridge 48 to extinguish the fire. The fusible bag bottom 62 decomposes at the temperature of a typical grease fire (approximately 768 F.) and has a layer of absorbent fibers 60 that will absorb the flammable grease thereby preventing the cooking grease from re-igniting.

This invention incorporates the use of a battery 38 of FIG. 6 to power the alarm 42. When the case top half 26 and case bottom half 28 are opened, puncture pin 52 is pushed by puncture pin spring 54 into the secondary puncture pin 49 which is pushed to the wiring contacts 43a and 43b to complete the circuit to the battery 38 and alarm 42. In the event the battery 38 is removed or too weak to power the alarm 42, the alarm 42 will not sound, however, the Automatic Stove Top Fire Extinguisher is mechanical and will retain all of its fire extinguishing capabilities.

The positive battery terminal 40a of the battery 38 is connected to the wiring contact 43a. The other side of the wiring contact 43b is connected to the positive side of the alarm 42. The negative side of the alarm 42 is connected directly to the negative battery terminal 40b of the battery 38. The test button 44 is connected to the wiring contacts 43a and 43b. When the extinguisher is deployed, the secondary puncture pin 49 is forced into the wiring contacts 43a and 43b to complete the circuit from the battery 38 to the alarm 42. Pressing the test button 44 simulates the secondary puncture pin 49 completing the circuit by shorting wiring contacts 43a and 43b together to complete the circuit and test the alarm 42.

### RAMIFICATIONS AND SCOPE OF THE INVENTION

Thus the reader will see that the Automatic Stove Top Fire Extinguisher of the invention provides an easily understood and mounted module for the user. Said extinguisher may be used for other applications such as recreational vehicles, restaurants and boats. Any enclosure that allows the possibility of catching on fire may benefit from the use of this invention in alternative configuration. While my description above contains specificities, these should not be construed as limitations on the scope of the invention, but rather as an exemplification of one preferred embodiment thereof. Many other variations are possible. For a more complex version, an electrical extension or a mechanical release for the module may also be used to disconnect the supply line for the gas or electricity supplying the energy for the stove. Other additions possible to improve the performance of the Automatic Stove Top Fire Extinguisher may include another coating of smoke absorbing material, inside the inflatable bag to diminish the result of smoke damage from stove top fires. Another possibility would be the use of a non flammable foam or inert material to inflate the flame proof bag versus the inert gas. Yet another configuration would be the use of an absorbent chemical such as Borax in the bottom layer of said bag. Still another method would be the use of a flame proof, yet absorbent material on said bag bottom that remains intact to suffocate the grease fire, versus the use of the decomposable material for the bag bottom.

Having described my invention, I claim:

1. A method of isolating the stove top fire, containing the heat and extinguishing all cooking stove top grease fires, while rendering the grease incapable of re-igniting, comprising the steps of:
Positioning a module being self contained, on or in the cavity of a vent hood, over the center of the cook stove;
said module is held closed with a fusible cord that melts at the temperature of a burning grease fire and;
said module automatically opening and inflating a bag with inert gas, to cover any and all grease fires that may be present on the cooking stove top and;
the bag being constructed of flame resistant materials and a bag bottom constructed of two layers of material (example: Nylon) that will decompose but not continue to burn, at the temperature of burning grease and a third internal layer, between the two layers of decomposable material, being constructed of non-flammable absorbent fibers;
said bag bottom, upon decomposition, releases said absorbent fibers to be deposited directly into the cooking container containing the grease fire;
said bag allows the cooking container containing the grease fire to enter said bag bottom, the said inflated bag with the said flame resistant material that is filled with said inert gas isolate the fire from the remainder of the cooking stove top and contain it thereby depriving it of necessary oxygen and extinguishing the grease fire;
while said inflated bag and said inert gas contain the extinguished grease fire, said bag bottom continues to decompose and deposit said layer of non-flammable absorbent fiber directly into the extinguished grease without dispersing chemicals at random; thereby rendering the previously burning grease fire incapable of re-igniting.

2. The method according to claim 1 including the step of providing a bag that is inflatable with an inert gas or non-flammable material.

3. The method according to claim 2 of providing said inflatable bag with said bag bottom that will decompose at a grease fire temperature to also deposit said non-flammable absorbent fiber precisely where it will be most effective, in the cooking container containing the grease fire and prevent random distribution of said non-flammable absorbent fibers.
